(19) United States
(12) Patent Application Publication
(10) Pub. No.: US 2025/0111963 A1
(43) Pub. Date: Apr. 3, 2025

(54) MULTI-CORE CABLE

(71) Applicant: SUMITOMO ELECTRIC INDUSTRIES, LTD., Osaka (JP)

(72) Inventor: Takaaki OKAMOTO, Tochigi (JP)

(21) Appl. No.: 18/754,648

(22) Filed: Jun. 26, 2024

(30) Foreign Application Priority Data
Sep. 29, 2023 (JP) 2023-170569

(51) Int. Cl. H01B 7/18; H01B 7/00

(52) U.S. Cl. CPC H01B 7/18; H01B 7/0009

(57) ABSTRACT

A multi-core cable includes: a core in which a plurality of coated electric wires are stranded; a jacket positioned outside the core; and a shield layer positioned between the core and the jacket. The shield layer includes a braided conductor in which metal wires are braided. An outer diameter of the metal wires is 0.05 mm or greater and 0.08 mm or less. A braiding density of the braided conductor is 91% or higher, and a braiding pitch of the braided conductor is five times or more and six times or less an outer diameter of the core.

### CROSS-REFERENCE TO RELATED APPLICATION

The present application claims priority under 35 U.S.C. § 119 to Japanese Patent Application No. 2023-170569, filed Sep. 29, 2023, the contents of which are incorporated herein by reference in their entirety.

### BACKGROUND OF THE INVENTION

### Field of the Invention

The present disclosure relates to a multi-core cable.

### Description of the Related Art

Japanese Patent Application Laid-Open Publication No. 2017-10747 discloses a transmission cable conforming to the USB Type-C standard and including a shield layer.

### SUMMARY OF THE INVENTION

A multi-core cable according to the present disclosure includes:
a core in which a plurality of coated electric wires are stranded;
a jacket positioned outside the core; and
a shield layer positioned between the core and the jacket,
wherein the shield layer includes a braided conductor in which metal wires are braided,
an outer diameter of the metal wires is 0.05 millimeters (mm) or greater and 0.08 mm or less, and
a braiding density of the braided conductor is 91 percent (%) or higher, and a braiding pitch of the braided conductor is five times or more and six times or less an outer diameter of the core.

### BRIEF DESCRIPTION OF THE DRAWINGS

FIG. 1 is a cross-sectional view of a multi-core cable according to an embodiment of the present disclosure, taken along a surface perpendicular to a longer direction of the multi-core cable.

FIG. 2A is a view illustrating a braided conductor.

FIG. 2B is a view illustrating a braiding pitch.

FIG. 3 is a view illustrating a sounding test.

### DETAILED DESCRIPTION OF THE DISCLOSURE

Embodiments for reduction to practice will be described below.

### Problem to be Solved by the Present Disclosure

There have been cases where multi-core cables cause a phenomenon referred to as sounding, in which sounds occur due to multi-core cables being twisted under forces applied to the multi-core cables during, for example, use of the devices to which the multi-core cables are connected. Repetitive occurrence of sounding may give users a sense of uncomfortableness depending on the installation environment of the multi-core cables. Therefore, it has been required to inhibit sounding of the multi-core cables.

Thus, an object of the present disclosure is to provide a multi-core cable that inhibits sounding when it is twisted.

### Effects of the Present Disclosure

According to the present disclosure, it is possible to provide a multi-core cable that inhibits sounding when it is twisted.

### Description of the Embodiments of the Present Disclosure

First, the embodiments of the present disclosure will be described in a list form. In the following description, the same or corresponding components will be denoted by the same reference numerals, and duplicate descriptions about them will not be repeated.

(1) A multi-core cable according to an embodiment of the present disclosure includes:
a core in which a plurality of coated electric wires are stranded;
a jacket positioned outside the core; and
a shield layer positioned between the core and the jacket,
wherein the shield layer includes a braided conductor in which metal wires are braided,
an outer diameter of the metal wires is 0.05 mm or greater and 0.08 mm or less, and
a braiding density of the braided conductor is 91% or higher, and a braiding pitch of the braided conductor is five times or more and six times or less an outer diameter of the core.

Friction between the core and the jacket at a position at which the shield layer is loosened is considered the cause of sounding. By adjustment of the outer diameter of the metal wires, the braiding density, and the braiding pitch within predetermined ranges, it is considered that the shield layer becomes less likely to loosen when the multi-core cable is twisted. Therefore, the multi-core cable according to an embodiment of the present disclosure is considered able to inhibit sounding notably.

(2) In a cross-section of the core perpendicular to a longer direction of the core,
the plurality of coated electric wires are positioned in a plurality of layers about a center of the core, and
those of the plurality of coated electric wires that are positioned to be on an outer surface of the core may be positioned along a circumscribed circle of the core.

If the coated electric wires positioned on the outer surface are varied in the distance from the center of the core in a cross-section of the core, some coated electric wires project more to the outside than other coated electric wires, and would readily come into contact with the shield layer. It is considered that sounding is likely to occur due to the coated electric wires, projecting more to the outside than other coated electric wires, contacting the shield layer. By positioning the plurality of coated electric wires in a plurality of layers about the center of the core and positioning a plurality of coated electric wires that are to be positioned on the outer surface of the core such that they are along a circumscribed circle in a cross-section of the core perpendicular to the longer direction of the core, it is possible to bring the cross-section of the core close to a circle. Therefore, it is possible to inhibit some of the coated electric wires from projecting more to the outside than other coated electric wires in the cross-section of the core perpendicular to the longer direction of the core. As a result, it is considered possible to inhibit sounding notably when the multi-core cable is twisted.

### Details of the Embodiments of the Present Disclosure

Specific examples of the multi-core cable according to an embodiment (hereinafter, referred to as “the present embodiment”) of the present disclosure will be described below with reference to the drawings. The present disclosure is not limited to these examples, is represented by the claims, and is intended to include all changes that are within the meaning and scope of equivalence to the claims.

In the present specification, members may be described by addition of “first”, “second”, “third”, and the like to the names of the members, such as a first electric wire, a second electric wire, a third electric wire, and the like, a first conductor, a second conductor, a third conductor, and the like, and a first insulator, a second insulator, a third insulator, and the like. “First”, “second”, “third”, and the like are only added to distinguish between the members and to prevent confusion in the description, and are not intended to represent positioning, priority, and the like. Therefore, in a case where there is no particular fear of confusion or in a case of describing the members collectively, they may be simply expressed as electric wires, conductors, insulators, and the like.

### [Multi-Core Cable]

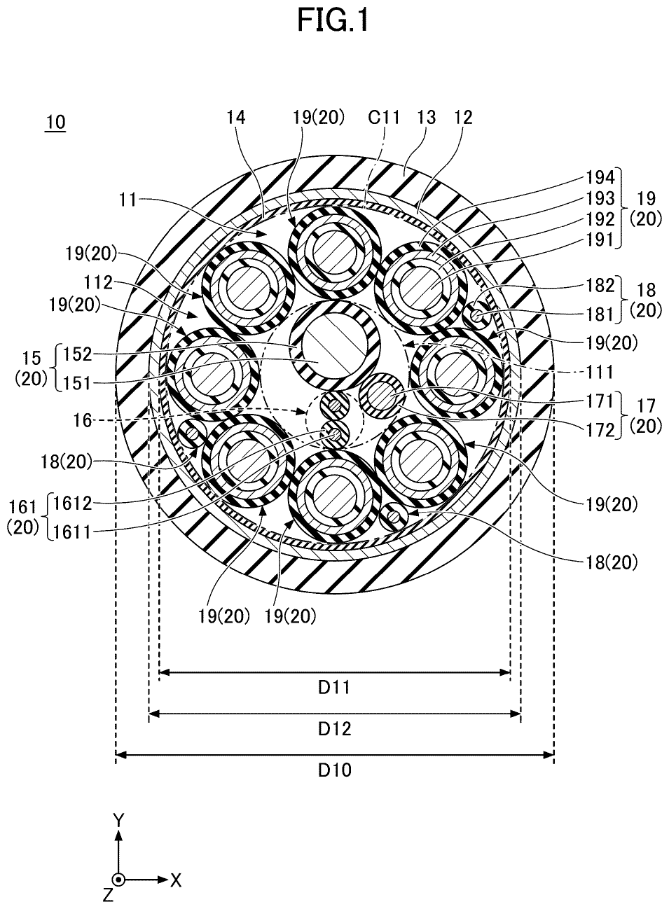

FIG. 1 illustrates an example of the configuration in the cross-section of the multi-core cable according to the present embodiment, perpendicular to the longer direction of the multi-core cable. The direction starting from the sheet of FIG. 1 and extending along the Z-axis is the longer direction of a multi-core cable 10 and a core 11. The XY plane is a cross-section of the multi-core cable 10 or the core 11 perpendicular to the longer direction of the multi-core cable 10 or the core 11.

As illustrated in FIG. 1, the multi-core cable 10 according to the present embodiment includes the core 11, and a jacket 13 positioned outside the core 11. The multi-core cable 10 according to the present embodiment includes a shield layer 12 positioned between the core 11 and the jacket 13.

Each member of the multi-core cable according to the present embodiment will be described.

### (1) Core

### (1-1) About the Members of the Core

The core 11 includes a plurality of coated electric wires 20.

(1-1-1) about the Coated Electric Wires

The coated electric wires 20 of the core 11 are not particularly limited, and may be selected in accordance with properties and the like required of the multi-core cable 10.

The multi-core cable 10 may include electric wires or coaxial wires as the coated electric wires 20. The multi-core cable 10 may include non-coated drain wires or the like as needed, in addition to the coated electric wires 20. By stranding the plurality of coated electric wires 20 of the multi-core cable 10, it is possible to form the core 11.

The multi-core cable 10 illustrated in FIG. 1 includes, as the coated electric wires 20, a first electric wire 15, a twisted pair electric wire 16, a third electric wire 17, fourth electric wires 18, and coaxial wires 19.

The configuration of the coated electric wires 20 will be described in the following order: electric wires, which include the first electric wire 15, second electric wires 161, the third electric wire 17, and the fourth electric wires 18; the coaxial wires 19; and the twisted pair electric wire 16.

### (A) Electric Wires

Each electric wire may include a conductor, and an insulator coating the outer surface of the conductor.

The first electric wire 15 of the multi-core cable 10 illustrated in FIG. 1 may include a first conductor 151 serving as the conductor, and a first insulator 152 serving as the insulator coating the outer surface of the first conductor 151.

Each second electric wire 161 may include a second conductor 1611 serving as the conductor, and a second insulator 1612 serving as the insulator coating the outer surface of the second conductor 1611.

The third electric wire 17 may include a third conductor 171 serving as the conductor, and a third insulator 172 serving as the insulator coating the outer surface of the third conductor 171.

Each fourth electric wire 18 may include a fourth conductor 181 serving as the conductor, and a fourth insulator 182 serving as the insulator coating the outer surface of the fourth conductor 181.

An example of the configuration of the members of each electric wire will be described.

### (A-1) Conductor

The conductor may include a single conductor element wire, or a plurality of conductor element wires. In a case where the conductor includes a plurality of conductor element wires, the plurality of conductor element wires may be stranded. That is, in a case where the conductor includes a plurality of conductor element wires, the conductor may be a stranded wire formed of the plurality of conductor element wires.

The material of the conductor is not particularly limited. For example, one or more conductor materials selected from copper alloys, copper, silver-plated soft copper, and tin-plated soft copper may be used. As the copper, soft copper may be used.

### (A-2) Insulator

The materials constituting the insulator are not particularly limited, and may include a resin material.

As the resin material, for example, one or more selected from: fluorine resins, such as polytetrafluoroethylene (PTFE), tetrafluoroethylene-perfluoroalkyl vinyl ether copolymers (PFA), tetrafluoroethylene-hexafluoropropylene copolymers (FEP), ethylene-tetrafluoroethylene copolymers (FTFE), and the like; polyester resins, such as polyethylene terephthalate (PET) and the like; and polyolefin resins, such as polyethylene, polypropylene, polymethyl pentene, and the like may be used. The resin material contained in the insulator may be crosslinked, but does not need to be crosslinked.

The insulator may be constituted only by the resin material specified above, yet may contain one or more additives selected from a flame retardant, a flame retardant promotor, an antioxidant, a lubricant, a colorant, a reflection agent, a masking agent, a processing stabilizer, a plasticizer, and the like, in addition to the resin material.

### (B) Coaxial Wire

As illustrated in FIG. 1, each coaxial wire 19 may include a fifth conductor 191, a fifth insulator 192 coating the outer surface of the fifth conductor 191, an outer conductor 193 coating the outer surface of the fifth insulator 192, and an outer-circumferential coating 194 coating the outer surface of the outer conductor 193.

Descriptions of the fifth conductor 191 and the fifth insulator 192 will be omitted, because they may be configured in the same manner as, for example, the conductor and the insulator described under the “Electric wires” section.

The outer conductor 193 and the outer-circumferential coating 194 will be described.

### (B-1) Outer Conductor

The outer conductor 193 may include, for example, a metal element wire, a metal foil, or a metal film (vapor-deposited film).

In a case where the outer conductor 193 includes a metal element wire, for example, a product obtained by stranding a plurality of metal element wires in a served shielding manner or a braiding manner may be used. As the material of the metal element wire, for example, copper, copper alloys, aluminum, aluminum alloys, and the like may be used. As the metal element wire, a soft copper wire or a hard copper wire may be used. The metal element wire may be plated with silver or tin on the surface. Therefore, as the metal element wire, for example, silver-plated copper alloys, tin-plated copper alloys, and the like may also be used.

In a case where the outer conductor 193 includes a metal foil or a metal film, for example, copper, copper alloys, aluminum, aluminum alloys, and the like may be used as the material of the metal foil or the metal film. In a case where the outer conductor 193 includes a metal foil or a metal film, for example, it is possible to obtain the outer conductor 193 by positioning a conductive tape, in which the metal foil or the metal film is deposited on a base material, on the outer surface of the fifth insulator 192.

### (B-2) Outer-Circumferential Coating

The outer-circumferential coating 194 may contain a resin material. The resin material may be one or more selected from polyolefin, polyester, polyvinyl chloride (PVC), and fluorine resins.

The outer-circumferential coating 194 may also contain various additives, such as a flame retardant, in addition to the resin material.

The resin material of the outer-circumferential coating 194 may be crosslinked, or does not need to be crosslinked.

### (C) Twisted Pair Electric Wire

For example, some of the coated electric wires 20 of the core 11 may be previously stranded as a twisted pair electric wire or the like. In the case of the multi-core cable 10 illustrated in FIG. 1, two second electric wires 161 are stranded as the twisted pair electric wire 16.

### (1-2) About the Core Configuration

The core 11 may have a configuration obtained by stranding the plurality of coated electric wires 20.

The configuration in a case of stranding the plurality of coated electric wires 20 is not particularly limited. For example, as illustrated in FIG. 1, the plurality of coated electric wires 20 may be positioned in a plurality of layers about the center of the core 11 in a cross-section of the core 11 perpendicular to the longer direction of the core 11.

In the core 11 of the multi-core cable 10 illustrated in FIG. 1, the plurality of coated electric wires 20 are stranded while being positioned in two layers including a first layer 111 and a second layer 112.

A plurality of coated electric wires 20 positioned on the outer surface, i.e., on the outermost layer, of the core 11, may be positioned along a circumscribed circle C11 of the core 11. In the case of the multi-core cable 10 illustrated in FIG. 1, the coated electric wires 20 positioned in the second layer 112 are the coated electric wires 20 positioned on the outer surface.

If the coated electric wires 20 positioned on the outer surface are varied in the distance from the center of the core 11 in a cross-section of the core perpendicular to the longer direction of the core, some coated electric wires 20 project more to the outside than other coated electric wires 20, and would readily come into contact with the shield layer 12. It is considered that sounding is likely to occur due to the coated electric wires 20, projecting more to the outside than other coated electric wires 20, contacting the shield layer 12. By positioning the plurality of coated electric wires 20 in a plurality of layers about the center of the core 11 and positioning a plurality of coated electric wires 20 to be positioned on the outer surface of the core 11 such that these coated electric wires 20 are along the circumscribed circle C11 in a cross-section of the core perpendicular to the longer direction of the core, it is possible to bring the cross-section of the core 11 close to a circle. Therefore, it is possible to inhibit some of the coated electric wires 20 from projecting more to the outside than other coated electric wires 20 in the cross-section of the core 11 perpendicular to the longer direction of the core 11. As a result, it is considered possible to inhibit sounding notably when the multi-core cable is twisted.

### (2) Shield Layer

The shield layer 12 may be positioned between the core 11 and the jacket 13.

By the multi-core cable 10 including the shield layer 12, it is possible to inhibit noise from being superimposed on a signal transmitted through the coated electric wires 20, and to inhibit effects of the noise on external devices.

The present inventor has studied a multi-core cable that can inhibit occurrence of sounding when it is twisted. As a result, the present inventor has found it possible to inhibit occurrence of sounding by selectively configuring the shield layer, and has completed the present disclosure.

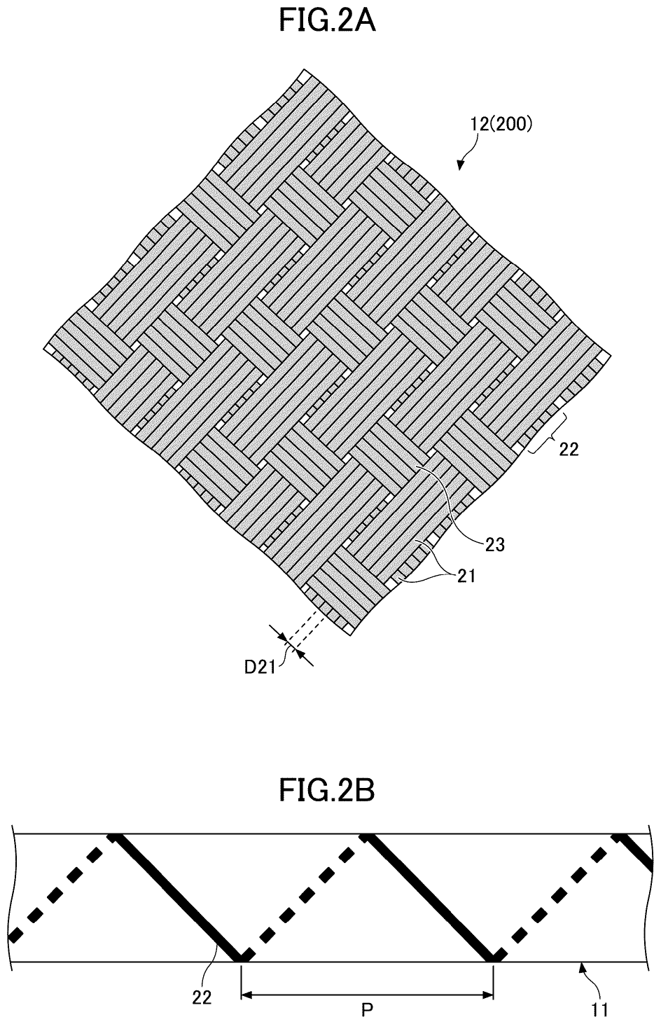

Hence, the shield layer 12 of the multi-core cable 10 according to the present embodiment may include a braided conductor 200 obtained by braiding metal wires 21, as illustrated in FIG. 2A. As illustrated in FIG. 2A, the braided conductor 200 may have a structure in which metal wire bundles 22, each including a plurality of metal wires 21, are braided to intersect each other and have a braided stitch 23 at the intersection. The number of metal wire bundles 22, each including a plurality of metal wires 21, in the braided conductor 200 may be referred to as, for example, the number of bundles for the sake of expediency, and the number of metal wires 21 included in the metal wire bundle 22 may be referred to as, for example, the number of wires for the sake of expediency.

The material of the metal wires 21 used in the braided conductor 200 included in the shield layer 12 is not particularly limited. For example, metal materials, such as copper, copper alloys, aluminum, aluminum alloys, and the like, or tin-plated soft copper, silver-plated soft copper, and the like, which are materials obtained by plating the surface of these metal materials, may be used. As the copper, soft copper may also be used.

The outer diameter D21 of the metal wires 21 may be 0.05 mm or greater and 0.08 mm or less.

The braiding density of the braided conductor 200 may be 91% or higher, and may be 91% or higher and 95% or lower.

The braiding density means the proportion of the area occupied by the metal wire 21 parts in the unit area of the braided conductor 200.

The metal wire bundles 22, each being a bundle of a plurality of parallel metal wires 21, are braided as the braided conductor 200 on the outer circumference of the core 11. Therefore, the same metal wire bundle 22 appears at a constant pitch along the longer direction of the core 11.

FIG. 2B is an exemplary view illustrating only one metal wire bundle 22 that is included in the braided conductor 200 positioned on the outer circumference of the core 11, for explaining the braiding pitch P. As illustrated in FIG. 2B, the cable length taken by the metal wire bundle 22 included in the braided conductor 200 to make one round around the core 11 along the longer direction of the core 11 is referred to as the braiding pitch P.

In the multi-core cable 10 according to the present embodiment, the braiding pitch P may be five times or more and six times or less the outer diameter D11 of the core 11.

Friction between the core and the jacket at a position at which the shield layer 12 is loosened is considered the cause of sounding. By adjustment of the outer diameter D21 of the metal wires 21, the braiding density, and the braiding pitch within predetermined ranges, it is considered that the shield layer becomes less likely to loosen when the multi-core cable 10 is twisted. Therefore, the multi-core cable 10 according to the present embodiment is considered able to inhibit sounding notably by inhibiting the outer surface of the core 11 from being contacted by a part at which the braided element wires are loosened.

In a case of positioning a press winding 14 on the outer surface of the core 11, the outer diameter of the press winding 14 is the outer diameter D11 of the core 11.

### (3) Jacket

The jacket 13 may be positioned outside the core 11.

The material of the jacket 13 is not particularly limited. The jacket 13 may contain a resin material. Examples of the resin material include: a polyolefin, such as polyethylene; polyvinyl chloride (PVC); thermoplastic elastomer (TPE); and the like.

The jacket 13 may contain various additives, such as a flame retardant, in addition to the resin material.

The material of the jacket 13 may be crosslinked, but does not need to be crosslinked.

By the multi-core cable 10 including the jacket 13, it is possible to protect the coated electric wires 20 and the shield layer 12 that are positioned inside.

### (4) Press Winding

The multi-core cable 10 may include a press winding 14 that covers the outer surface of the core 11.

By the multi-core cable 10 including the press winding 14, it is possible to bundle the coated electric wires 20 of the multi-core cable 10 while stabilizing their positioning.

As the press winding 14, for example, a resin tape, a paper tape, or a nonwoven fabric tape may be used.

As the resin of the resin tape, one or more selected from fluorine resins, such as polytetrafluoroethylene (PTFE) excellent in heat resistance, wear resistance, and the like, polyester resins, such as polyethylene terephthalate (PET), polyethylene (PE), and the like may be used.

The resin tape used as the press winding 14 may contain a conductive substance, such as carbon, in order to have conductivity. The conductive substance may be added dispersedly in the resin constituting the resin tape. Moreover, a metal tape obtained by depositing a copper foil or an aluminum foil on the surface of the resin tape may be used.

The winding direction of the press winding 14 may be the same direction as or the opposite direction to the stranding direction of the coated electric wires 20 constituting the core 11.

By the multi-core cable 10 including the press winding 14, it is possible to inhibit the insulators of the coated electric wires 20 constituting the core 11 from being damaged when positioning the shield layer 12 outside the core 11.

### Examples

Specific Examples will be described below for illustration. However, the present disclosure should not be construed as being limited to these Examples.

### (Evaluation Method)

First, the method for evaluating multi-core cables produced in the following Experimental Examples will be described.

(1) The outer diameter D11 of the core, the outer diameter D12 of the shield layer, the outer diameter D10 of the multi-core cable, and the outer diameter D21 of the metal wires

The outer diameters D11, D12, D10, and D21 of the core 11, the shield layer 12, the multi-core cable 10, and the metal wires included in the multi-core cables produced in the following Experimental Examples were measured by a method described in Japanese Industrial Standards (JIS) C 3005 (2014).

A micrometer was used to measure the outer diameter D21 of the metal wires. A caliper was used to measure the outer diameters of the members other than the metal wires.

Specifically, in a desirably selected cross-section of the multi-core cable 10 or the metal wires 21 perpendicular to the longer direction of the multi-core cable 10 or the metal wires 21, the lengths of two orthogonal diameters of each member to be measured were measured, and the average of the values were used as the outer diameter of the member.

### (2) Braiding Density

The braiding density of the braided conductor 200 included in the shield layer 12 of the multi-core cables 10 produced in the following Experimental Examples was calculated by a formula (1), a formula (2), and a formula (3) below.

$$γ = ( 2 F - {F}^{2} ) \times 100 \qquad ( 1 )$$

$$F = \frac{N C d}{2 P sin α} \qquad ( 2 )$$

$$sin α = \frac{π ( D + 2 d )}{\sqrt{{π}^{2} {( D + 2 d )}^{2} + {P}^{2}}} = \frac{1}{\sqrt{1 + {\{ \frac{P}{π ( D + 2 d )} \}}^{2}}} \qquad ( 3 )$$

In the formula (1), the formula (2), and the formula (3), γ represents the braiding density (%), N represents the number of wires, C represents the number of bundles, d represents the outer diameter D21 of the metal wires included in the braided conductor 200, P represents the braiding pitch (mm), and D represents the outer diameter D11 (mm) of the core.

### (3) Braiding Pitch

The metal wire bundle 22 to be measured was designated, and the cable length taken by the designated metal wire bundle 22 to make one round around the core along the longer direction of the core 11 was measured as the braiding pitch P.

### (4) Sounding Test

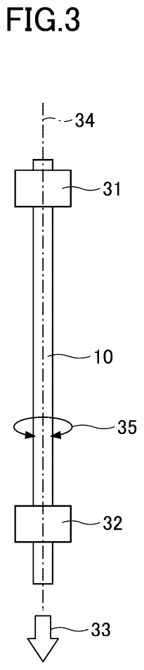

As illustrated in FIG. 3, the multi-core cable 10 having a length of 0.2 meters (m) produced in the following Experimental Examples was suspended vertically, and the upper end and the lower end of the multi-core cable 10 were gripped with a chuck 31 and a chuck 32, respectively. A load of 2 Newtons (N) was applied downward to the multi-core cable 10 along the block arrow 33 in FIG. 3.

Then, with the chuck 32 at the lower end fixed, the chuck 31 at the upper end was twisted at a speed at which it would be reciprocated once between a −90 degrees (°) position and a +90° position in 3 seconds about the axis 34 of the multi-core cable 10 serving as a rotation axis in the left-right direction along the double-headed arrow 35.

Here, an observer was positioned such that his/her ear would be at a distance of within 50 mm from the multi-core cable 10, such that he/she would give a rating B when a sound would be heard and would give a rating A when no sound would be heard.

In a case of the rating A, the multi-core cable could be evaluated as one that succeeded in inhibiting occurrence of sounding upon twisting.

### (Experimental Conditions, and Results)

Multi-core cables of the respective Experimental Examples will be described below.

Multi-core cables of the following Experimental Example 1 and Experimental Example 2 were produced. Experimental Example 1 was a Comparative Example, and Experimental Example 2 was an Example.

### Experimental Example 1

As illustrated in FIG. 1, a multi-core cable 10 having the structure of the cross-section illustrated in FIG. 1, which is perpendicular to the longer direction, was produced.

As illustrated in FIG. 1, in a cross-section perpendicular to the longer direction of the multi-core cable 10, a plurality of coated electric wires 20 were stranded while being positioned in two layers, including a first layer 111 and a second layer 112, as counted from the center of the core 11. A plurality of coated electric wires 20 positioned on the outer surface of the core 11 were positioned along the circumscribed circle C11 of the core 11. The coated electric wires 20 included in the core 11 are as described above.

In the order from closest to the core 11, a press winding 14, a shield layer 12, and a jacket 13 were positioned outside the core 11.

The configuration of the braided conductor 200 in the shield layer 12 is as indicated in the “Braiding” field of Table 1.

The evaluation result is indicated in Table 1.

### Experimental Example 2

The outer diameter D21 of the metal wires used in the shield layer 12, and the configuration of the braided conductor were changed to become the values indicated in Table 1. A multi-core cable 10 was produced under the same conditions as in Experimental Example 1 except the above points.

The evaluation result is indicated in Table 1.

TABLE 1

| | | Experimental | Experimental |
|---|---|---|---|
| | | Example 1 | Example 2 |
| Multi-core cable outer diameter D10 (mm) | | 4.62 | 4.65 |
| Braiding | Outer diameter D12 (mm) | 3.75 | 3.82 |
| | Braiding pitch P (mm) | 28.18 | 18 |
| | Metal wire outer | 0.049 | 0.064 |
| | diameter D21 (mm) | | |
| | Braiding density (%) | 89 | 93 |
| | Configuration | 16/18 | 16/14 |
| | (Number of bundles/Number | | |
| | of wires) | | |

| | | |
|---|---|---|
| Core outer diameter D11 (mm) | 3.53 | 3.5 |
| P/D11 | 8.0 | 5.1 |
| Sounding test evaluation | B | A |

What is claimed is:

1. A multi-core cable, comprising:
a core in which a plurality of coated electric wires are stranded;
a jacket positioned outside the core; and
a shield layer positioned between the core and the jacket,
wherein the shield layer includes a braided conductor in which metal wires are braided,
an outer diameter of the metal wires is 0.05 mm or greater and 0.08 mm or less, and
a braiding density of the braided conductor is 91% or higher, and a braiding pitch of the braided conductor is five times or more and six times or less an outer diameter of the core.

2. The multi-core cable according to claim 1,
wherein in a cross-section of the core perpendicular to a longer direction of the core,
the plurality of coated electric wires are positioned in a plurality of layers about a center of the core, and
those of the plurality of coated electric wires that are positioned to be on an outer surface of the core are positioned along a circumscribed circle of the core.
